(19) United States
(12) Patent Application Publication
(10) Pub. No.: US 2017/0093941 A1
(43) Pub. Date: Mar. 30, 2017

(54) DISTRIBUTION APPARATUS AND METHOD FOR DISTRIBUTION

(71) Applicants: Yoshihiko SHIMOHIRA, Kanagawa (JP); Takahiro KAMEKURA, Tokyo (JP)

(72) Inventors: Yoshihiko SHIMOHIRA, Kanagawa (JP); Takahiro KAMEKURA, Tokyo (JP)

(21) Appl. No.: 15/267,422

(22) Filed: Sep. 16, 2016

(30) Foreign Application Priority Data
Sep. 29, 2015 (JP) 2015-192116

(51) Int. Cl. H04L 29/06

(52) U.S. Cl. CPC H04L 65/4076; H04L 65/4084; H04L 65/1069

(57) ABSTRACT

A distribution apparatus includes a receiver configured to receive from one or more terminal devices one or more requests for distributing content, respectively, a memory, a determiner configured to acquire, from the memory, information as to one or more terminal devices for which the content is destined and configured to determine whether to start distributing the content based on a number of the one or more requests for distributing the content received by the receiver and a number of the one or more terminal devices for which the content is destined, the number of the one or more terminal devices being obtained from the information as to the one or more terminal devices for which the content is destined, and a distributor configured to start distributing the content to the one or more terminal devices for which the content is destined, based on a result of the determination.

### CROSS-REFERENCE TO RELATED APPLICATIONS

The present application claims the benefit of priority under 35 U.S.C. §119 of Japanese Patent Application No. 2015-192116, filed Sep. 29, 2015, the contents of which are incorporated herein by reference in their entirety.

### BACKGROUND OF THE INVENTION

1. Field of the Invention

The present disclosure relates to distribution apparatuses and methods for distribution.

2. Description of the Related Art

There is a system utilized at a school, etc., where movie data for class, etc., is stored in a distribution server for distributing content and then distributed from the distribution server to terminal devices of students (for example, see Japanese Unexamined Patent Application Publication No. H10-268741).

In such a system, for example, a teacher instructs a distribution server to distribute movie data to terminal devices during class. Upon such an instruction, the distribution server distributes the movie data to the terminal devices as instructed.

In such a way, students can watch distributed movie data on respective terminal devices during class.

### SUMMARY OF THE INVENTION

One aspect of the present invention provides a distribution apparatus including a receiver configured to receive from one or more terminal devices one or more requests for distributing content, respectively, a memory, a determiner configured to acquire, from the memory, information as to one or more terminal devices for which the content is destined and configured to determine whether to start distributing the content based on a number of the one or more requests for distributing the content received by the receiver and a number of the one or more terminal devices for which the content is destined, the number of the one or more terminal devices being obtained from the information as to the one or more terminal devices for which the content is destined, and a distributor configured to start distributing the content to the one or more terminal devices for which the content is destined, based on a result of the determination.

### BRIEF DESCRIPTION OF THE DRAWINGS

FIG. 1 is a drawing illustrating an example of a distribution system according to a first embodiment;

FIG. 2 is a drawing illustrating an example of a hardware configuration of a distribution server according to the first embodiment;

FIG. 3 is a drawing illustrating an example of a functional configuration of the distribution server according to the first embodiment;

FIG. 4 is a drawing illustrating an example of an information list of terminal devices which is stored in a memory according to the first embodiment;

FIG. 5 is a drawing illustrating an example of a functional configuration of a distribution controlling device according to the first embodiment;

FIG. 6 is a drawing illustrating an example of an operational sequence of sending an URL for distribution according to the first embodiment;

FIG. 7 is a drawing illustrating an example of an operational sequence of informing of completion of preparation of the terminal devices, according to the first embodiment;

FIG. 8 is a drawing illustrating an example of an operational sequence of displaying preparation status, according to the first embodiment;

FIG. 9 is a drawing illustrating an example of an operational sequence of distribution of content, according to the first embodiment; and

FIG. 10 is a drawing illustrating an example of an operational sequence of determination to start distribution, according to the first embodiment.

### DESCRIPTION OF THE EMBODIMENTS

In a distribution system described above, it is difficult for a distribution server to confirm that each of the terminal devices for which content is destined is prepared for receiving movie data. Hence, the distribution server may start distribution of the content even though some of the terminal devices are not prepared for receiving the movie data.

In view of such a background, the objective of the present invention is to enable distribution of content to be started in accordance with status of terminal devices for which the content is destined.

### First Embodiment

### System Configuration

(1) Overall Configuration

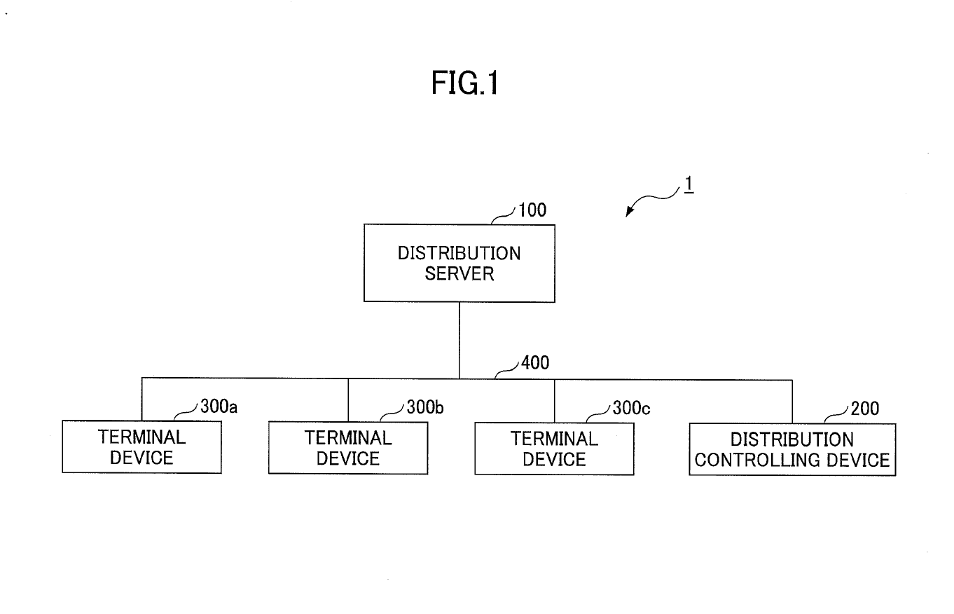

FIG. 1 is a drawing illustrating an example of a distribution system 1 according to the first embodiment. The distribution system 1 includes a distribution server 100, a distribution controlling device 200, and terminal devices 300 (also referred to as terminal devices 300a, 300b, and 300c, when differentiated). The distribution server 100, the distribution controlling device 200, and the terminal devices 300 are mutually connected via a network 400. The network 400 may be wired or wireless.

The distribution server 100 may be embodied by, for example, a general server or personal computer (PC), or an electronic blackboard, etc., which is capable of executing programs.

The distribution controlling device 200 and the terminal devices 300 may be embodied by tablet devices, smartphones, laptop PCs, etc.

Further, needless to say, the distribution server 100 and the distribution controlling device 200 may be embodied by a single physical device. The distribution server 100 stores content to be distributed. The distribution server 100 distributes the content to terminal devices 300 in accordance with instructions from a user of the distribution server 100 or the distribution controlling device 200.

For example, in a case where the distribution server 100 is an electronic blackboard, the distribution server 100 distributes content to the terminal devices 300, and also displays input information entered by a user and content being distributed.

Additionally, for example, in a case where the distribution server 100 is a PC or a server, the distribution server 100 distributes content to the terminal devices 300, and also displays input information entered by a user and content being distributed.

Furthermore, the distribution server 100 receives from each of the terminal devices 300 a signal indicating that the terminal device 300 is prepared for receiving content. Such a signal includes an identifier of each of the terminal devices 300. The distribution server 100 sends information of preparation status to the distribution controlling device 200. Further, the distribution server 100 may display the information of preparation status, so that a user of the distribution server 100 is informed.

Here, information of preparation status is information relating to preparation of the terminal devices 300 for receiving content.

For example, information of preparation status may be the number of terminal devices 300 to which content is supposed to be distributed (i.e. destination terminal devices) and the number of signals indicating that preparations for receiving the content are done. Alternatively, information of preparation status may be a list of identifiers of each of the destination terminal devices 300 and preparation status of each of the terminal devices 300 on the list.

Identifiers of the terminal devices 300 are information for identifying each of the terminal devices 300. For example, Media Access Control (MAC) addresses of the terminal devices 300 may be employed as identifiers.

In a case where the distribution system 1 is employed at a school, etc., it is assumed that a teacher utilizes the distribution controlling device 200 and students utilize the terminal devices 300. Before distributing content from the distribution server 100, the teacher prompts the students to operate the respective terminal devices 300 so that each of the terminal devices 300 is prepared to receive the content. The students perform activation processing, etc., of the terminal devices 300, so that each of the terminal devices 300 sends to the distribution server 100 a signal indicating that preparation for receiving the content is done.

The distribution server 100 sends to the distribution controlling device 200 information as to preparation for receiving the content. Upon receiving the information as to preparation for receiving the content, the distribution controlling device 200 displays the information. The teacher utilizing the distribution controlling device 200 checks the displayed information, and then determines whether distribution of the content may be started. Otherwise, the teacher may prompt the students to operate the respective terminal devices 300 again, so that each of the terminal devices 300 is prepared to receive the content.

The teacher provides an instruction to the distribution controlling device 200 to start distribution of the content. In accordance with the instruction, the distribution controlling device 200 instructs the distribution server 100 to start distribution of the content. In accordance with the instruction to start distribution of the content, the distribution server 100 starts distribution of the content to the terminal devices 300 for which the content is destined. The distributed content may be movie data. The distribution server 100 distributes the same content to all of the destination terminal devices 300 at the same timing. While distributing the content, the distribution server 100 may display the content being distributed on a display of the distribution server 100.

Here, in a predetermined condition, the distribution server 100 may distribute the content to the terminal devices 300 without receiving the instruction to start distribution from the distribution controlling device 200.

A predetermined condition may be, for example, when the distribution server 100 receives the signals indicating that preparations for distribution are done from all of the destination terminal devices 300.

In a case where a teacher utilizes the distribution server 100, the teacher may check preparation status on the distribution server 100, and the distribution server 100 may start distribution of content in accordance with an instruction from the teacher.

<Hardware Configuration>

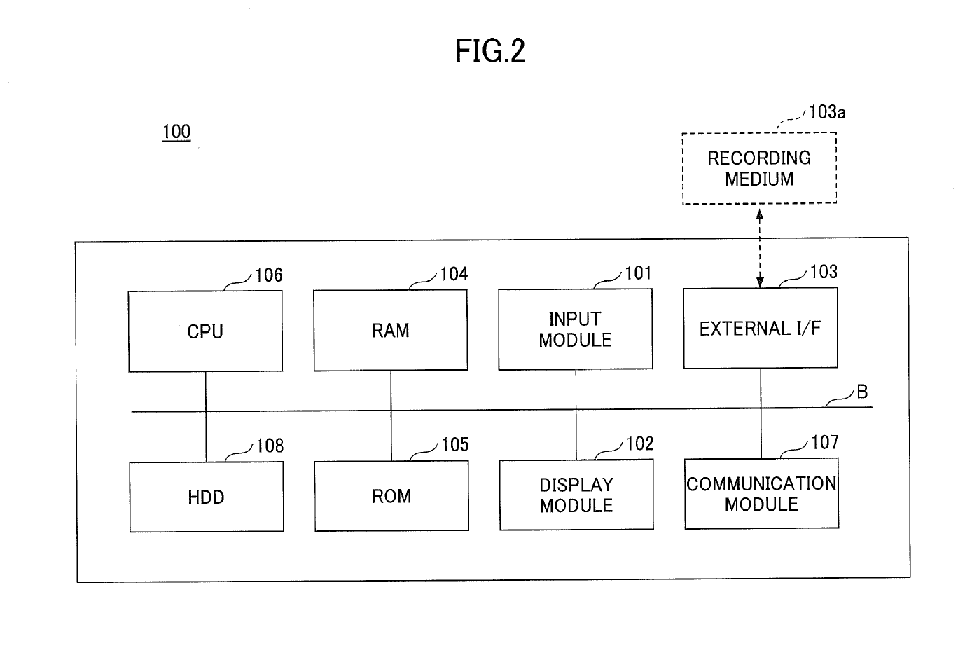

FIG. 2 is a drawing illustrating an example of a hardware configuration of the distribution server 100 according to the first embodiment.

The distribution server 100 includes a input module 101, a display module 102, an external interface (I/F) 103, a random access memory (RAM) 104, a read-only memory (ROM) 105, a central processing unit (CPU) 106, a communication module 107, a hard disk drive (HDD) 108, etc., which are mutually connected via a bus B.

The input module 101, such as a keyboard, a mouse, and a touch panel, is utilized so that a user enters operation signals.

The display module 102, such as a display, displays processing results of the distribution server 100. Further, the display module 102 displays input information entered through the input module 101 and also displays content for distribution.

The communication module 107 connects the distribution server 100 to the network 400. The distribution server 100 receives and transmits data through the communication module 107.

The HDD 108 is a non-volatile memory device storing programs and data. The stored programs and data may be, for example, an operation system (OS) which is basic software for overall control of the distribution server 100, application software implemented on the OS to provide functions, etc.

The HDD 108 manages the programs and data using a predetermined file system and/or a database (DB).

The external I/F 103 is an interface to an external device. The external device may be a recording medium 103a, etc. The distribution server 100 may perform read and write processing on the recording medium 103a through the external I/F 103.

The recording medium 103a may be a flexible disk, a compact disk (CD), a digital versatile disk (DVD), a secure digital (SD) memory card, a universal serial bus (USB) memory, etc.

The ROM 105 is a non-volatile semiconductor memory (i.e. memory device) capable of storing programs and data even though the power is off. The ROM 105 stores programs and data such as a Basic Input/Output System (BIOS) which is executed at the time of activating the distribution server 100, an OS setting, and a network setting.

The RAM 104 is a volatile semiconductor memory (i.e. memory device) which temporarily stores programs and data.

The CPU 106 is an arithmetic unit which retrieves programs and data from a memory device such as the ROM 105 and the HDD 108 onto the RAM 104 and then executes processing, so as to perform overall control of the distribution server 100 and to implement functions.

The distribution controlling device 200 may be constituted by the same hardware configuration as the hardware configuration of the distribution server 100.

The CPU 106 executes programs stored in the ROM 105, etc., so as to implement various functions of the distribution server 100 and the distribution controlling device 200 as described hereinafter.

<Functional Configuration>

(1) Distribution Server

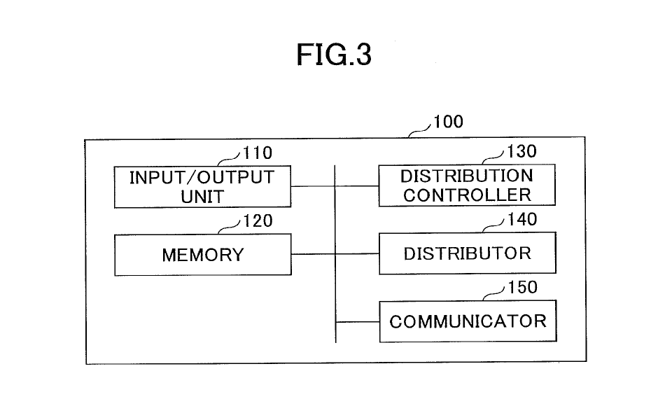

FIG. 3 is a drawing illustrating an example of a functional configuration of the distribution server 100 according to the first embodiment. The distribution server 100 includes an input/output unit 110, a memory 120, a distribution controller 130, a distributor 140, and a communicator 150.

Each function of the distribution server 100 cooperates as described below.

The communicator 150 receives a request for distribution of content from the terminal devices 300. The distribution controller 130 acquires, from the memory 120, information relating to the terminal devices 300 for which the content is destined, such as a list including identifiers of the respective terminal devices 300. Then, the distribution controller 130 determines whether to start distribution of the content, based on the number of requests for distribution received from the terminal devices 300 and the number of the destination terminal devices 300. In accordance with a result of the determination, the distributor 140 starts distribution of the content to the destination terminal devices 300.

Alternatively, functions of the distribution server 100 may cooperate as described below.

The communicator 150 receives a request for distribution of content including an identifier of each of the terminal devices 300 from the respective terminal devices 300. The distribution controller 130 acquires, from the memory 120, information relating to the terminal devices 300 for which the content is destined. Then, the distribution controller 130 determines whether to start distribution of the content, based on the number of requests for distribution received from the terminal devices 300 having identifiers obtained from the information relating to the terminal devices 300 for which the content is destined and the number of the terminal devices 300 for which the content is destined, which is obtained from the information relating to the terminal devices 300 for which the content is destined. In response to a determination of the distribution controller 130 to start distribution of the content, the distributor 140 starts distribution of the content to all of the destination terminal devices 300.

The functions of the functional parts will be specifically described in the following.

The input/output unit 110 displays information relating to the distribution server 100, and also displays input information entered by a user of the distribution server 100. Here, the user may be a person, such as a teacher, who operates the distribution controlling device 200. Further, while the distribution server 100 performs distribution of content, the input/output unit 110 displays the content being distributed.

The input/output unit 110 displays information relating to distribution status of content. For example, the input/output unit 110 displays status such as starting distribution of content, starting playing content, information of preparation status which indicates preparation status for receiving content, distribution status of content (pausing, etc.), and status of playing content (seeking video, etc.).

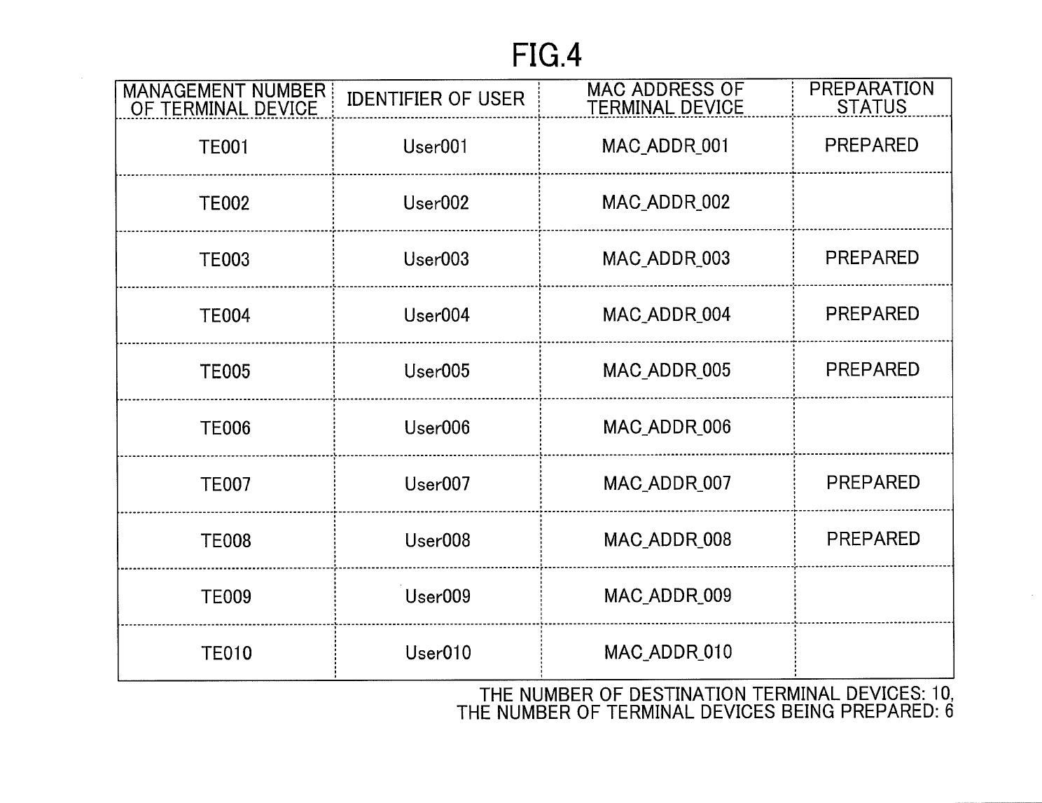

The memory 120 stores content to be distributed to the terminal devices 300. The memory 120 stores information of the destination terminal devices 300. With reference to FIG. 4, the information of the terminal devices 300 stored in the memory 120 will be explained. FIG. 4 is a drawing illustrating an example of an information list of the terminal devices 300 which is stored in the memory 120 according to the first embodiment.

In the memory 120, management numbers of the terminal devices 300, identifiers of users, MAC addresses of the terminal devices 300, and preparation status are stored, in association with each of the terminal devices 300. In the distribution system 1, each of the terminal devices 300 is identified based on at least one of the management numbers of the terminal devices 300, the identifiers of users, and the MAC addresses of the terminal devices 300. When the communicator 150 is informed by one of the terminal devices 300 that preparation for receiving content is done, the memory 120 updates the field of the preparation status to “PREPARED”. Here, a MAC address may be provided to the communicator 150 as well.

Referring to the information list of the terminal devices 300, the memory 120 may count and store the number of the destination terminal devices 300 and the number of the terminal devices 300 being prepared for receiving the content. In the example of FIG. 4, the number of the destination terminal devices 300 is “10”, and the number of the terminal devices 300 being prepared is “6”.

The distribution controller 130 retrieves content for distribution from the memory 120, and then plays the content. The distribution controller 130 instructs the distributor 140 to distribute content. The distribution controller 130 may perform various controls on content being distributed. For example, the distribution controller 130 may instruct to halt the content being distributed and to display status of playing the content.

The distribution controller 130 determines whether to start distribution of content, referring to an information list of the terminal devices 300 stored in the memory 120.

The distribution controller 130 may determine to start distribution of content, in a condition where the difference between the number of the destination terminal devices 300 and the number of the terminal devices 300 being prepared for receiving the content is in a predetermined range, because, in such a condition, the distribution controller 130 detects that more than a predetermined proportion of the destination terminal devices 300 are prepared for receiving the content. Here, the distribution controller 130 determines that distribution of the content may be started with no problems because the terminal devices 300 which are not prepared for receiving the content are considered able to become prepared within an acceptable range of time after distribution of the content is started.

Further, the distribution controller 130 may determine to start distribution of content, in a condition where the number of the destination terminal devices 300 and the number of the terminal devices 300 being prepared for receiving the content match, because, in such a condition, the distribution controller 130 detects that all of the destination terminal devices 300 are prepared for receiving the content.

The distribution controller 130 may instruct the input/output unit 110 to display a result of the determination. After the input/output unit 110 displays the number of the destination terminal devices 300 and the number of the terminal devices 300 being prepared for receiving the content in accordance with the instruction from the distribution controller 130, a user may provide an instruction to start distribution of the content. Further, the distribution controller 130 may send the result of the determination to the distribution controlling device 200 through the communicator 150. The distribution controlling device 200 may display the received information, so as to prompt a user of the distribution controlling device 200 to provide an instruction to start distribution of the content.

The distribution controller 130 may determine to start distribution of content, in a condition where the information that preparation for receiving the content is done is received from all of the terminal devices 300 included in the information list of the terminal devices 300 stored in the memory 120.

The distribution controller 130 may instruct the input/output unit 110 to display the information list of the terminal devices 300, so that a user of the distribution server 100 may check preparation status of the respective terminal devices 300, referring to the display of the information list.

The distribution controller 130 may send the information list of the terminal devices 300 to the distribution controlling device 200, so that the distribution controlling device 200 displays the received information list of the terminal devices 300. In such a case, a user of the distribution controlling device 200 may check preparation status of the respective terminal devices 300, referring to the display of the information list.

Here, the determination of starting distribution of content may be made by the distribution controller 130, or may be made based on an operation entered through the input/output unit 110 or through the distribution controlling device 200.

The distributor 140 starts distribution of content to all of the destination terminal devices 300, in response to an instruction from the distribution controller 130. The distributor 140 distributes the content to all of the destination terminal devices 300 at the same timing.

The communicator 150 sends and receives various information items in-between the terminal devices 300 and the distribution controlling device 200. For example, the communicator 150 sends information of preparation status to the distribution controlling device 200 in accordance with an instruction from the distribution controller 130. Further, the communicator 150 receives an instruction to start distribution of content, etc., from the distribution controlling device 200.

(2) Distribution Controlling Device

FIG. 5 is a drawing illustrating an example of a functional configuration of the distribution controlling device 200 according to the first embodiment.

The distribution controlling device 200 includes an input/output unit 210, a controller 220, and a communicator 230.

The input/output unit 210 displays various information items received from the distribution server 100 through the communicator 230. Further, the input/output unit 210 receives an instruction from a user of the distribution controlling device 200. For example, the input/output unit 210 displays information of preparation status received from the distribution server 100.

The input/output unit 210 sends the received instruction to the distribution server 100 through the communicator 230.

For example, the input/output unit 210 may display the number of the terminal devices 300 for which content is destined and the number of the terminal devices 300 being prepared for receiving the content, which are obtained from the received information of preparation status. The input/output unit 210 may display such information, so as to prompt a user of the distribution controlling device 200 to provide an instruction to start distribution of the content. In a case where the input/output unit 210 receives an input from the user of the distribution controlling device 200 to instruct to start distribution of the content, the input/output unit 210 instructs the distribution server 100 through the communicator 230 to start distribution of the content.

Furthermore, in a case of receiving the information list of the terminal devices 300 from the distribution server 100, the input/output unit 210 may display the list, so as to prompt the user of the distribution controlling device 200 to check preparation status of each of the terminal devices 300.

The controller 220 performs various controls on the distribution controlling device 200. The communicator 230 sends and receives various information items with the distribution server 100.

<Operational Sequence>

(1) Sending an URL for Distribution

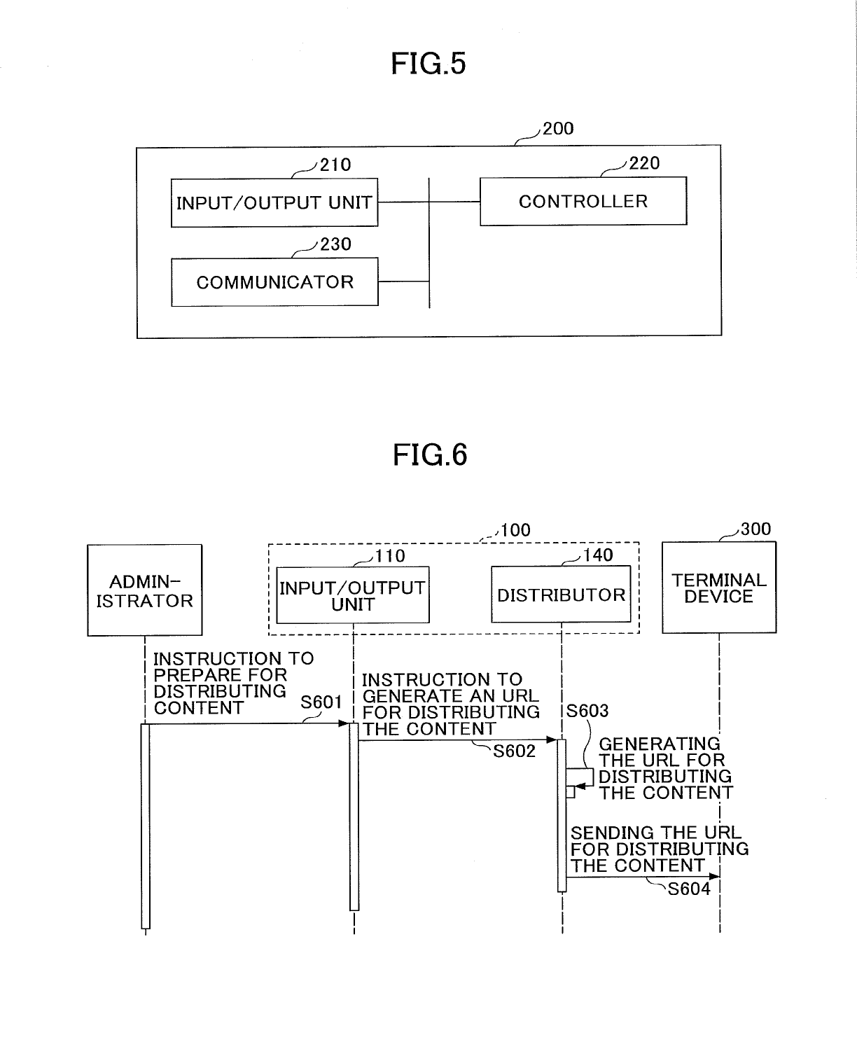

FIG. 6 is a drawing illustrating an example of an operational sequence of sending an URL for distribution according to the first embodiment.

In Step S601, the input/output unit 110 provided on the distribution server 100 receives an instruction from a user of the distribution server 100 to prepare for distribution.

In Step S602, the input/output unit 110 instructs the distributor 140 to generate a URL for distribution of content.

Here, the distributor 140 may receive the instruction to generate the URL for distribution of the content through the communicator 150.

In Step S603, the distributor 140 generates the URL for distribution of the content.

In Step S604, the distributor 140 sends the URL for distribution of the content to the destination terminal devices 300. Here, the distributor 140 may specify each of the destination terminal devices 300 based on an information list of the terminal devices 300 stored in the memory 120, so as to send the URL for distribution of the content to the specified terminal devices 300.

(2) Informing of Completion of Preparation of the Terminal Devices

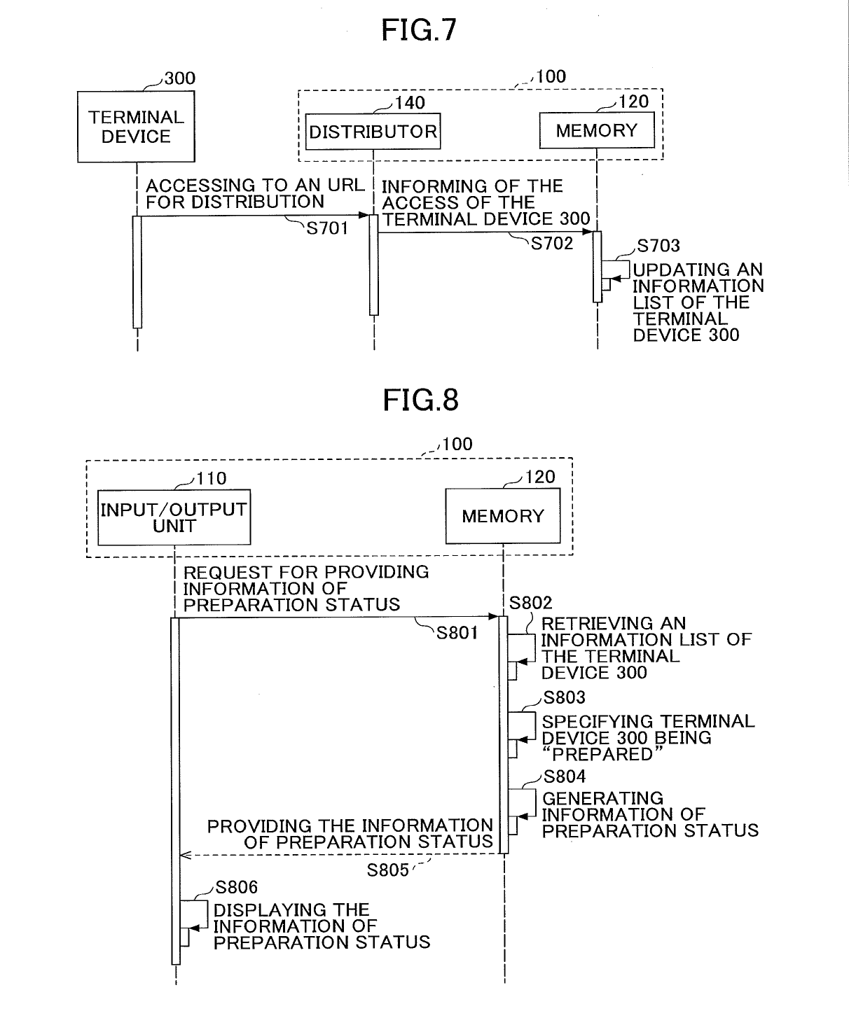

FIG. 7 is a drawing illustrating an example of an operational sequence of informing of completion of preparation of the terminal devices 300, according to the first embodiment. The sequence of FIG. 7 follows Step S604 of FIG. 6.

In Step S701, the terminal devices 300 access the received URL for distribution of the content. At the time of accessing, each of the terminal devices 300 informs the distributor 140 of at least one of a management number of the respective terminal device 300, an identifier of the respective user, and a MAC address of the respective terminal device 300.

In Step S702, the distributor 140 informs the memory 120 of the access of the terminal devices 300. The information regarding the access includes at least one of the management number of the respective terminal devices 300, the identifier of the respective users, and the MAC address of the respective terminal devices 300.

In Step S703, the memory 120 updates an information list of the terminal devices 300. Specifically, the memory 120 updates preparation status of each of the terminal devices 300 specified by either the management number of the respective terminal devices 300, the identifier of the respective users, and the MAC address of the respective terminal devices 300 to “PREPARED”.

Here, a benefit of specifying the terminal devices 300 by use of respective MAC addresses is that a user of each of the terminal devices 300 need not set an identifier, because MAC addresses are preset on the respective terminal devices 300.

(3) Displaying Preparation Status

FIG. 8 is a drawing illustrating an example of an operational sequence of displaying preparation status, according to the first embodiment. The sequence of FIG. 8 follows Step S604 of FIG. 6 where the URL for distribution of the content is sent to the terminal device 300.

In Step S801, the input/output unit 110 provided on the distribution server 100 sends a request for providing information of preparation status to the memory 120. Here, the information of preparation status indicates preparation status of the destination terminal devices 300. The information of preparation status may be referred to as the number of distribution requests received from the terminal devices 300.

The information of preparation status may include the number of the destination terminal devices 300 and the number of the terminal devices 300 whose preparation status is updated to “PREPARED”. Further, the information of preparation status may include identifiers of the terminal devices 300 whose preparation status are not updated to “PREPARED”.

In Step S802, the memory 120 retrieves the information list of the terminal devices 300.

In Step S803, the memory 120 specifies the terminal devices 300 whose preparation status is “PREPARED” in the information list of the terminal devices 300.

In Step S804, the memory 120 generates information of preparation status. For example, the memory 120 may generate the information of preparation status based on information including the number of the terminal devices 300 on the information list of the terminal devices 300 and the number of the terminal devices 300 whose preparation status is not “PREPARED” among the terminal devices 300 on the list.

The memory 120 may generate the information of preparation status based on a list of identifiers of users of the terminal devices 300 whose preparation status is not “PREPARED”. In such a case, the information of preparation status may include identifiers of the terminal devices 300 which correspond to the respective identifiers of the users.

Alternatively, the information of preparation status may be generated based on a list of the identifiers of the user of the terminal devices 300 whose preparation status is “PREPARED”. In such a case, the information of preparation status may include identifiers of the terminal devices 300 which correspond to the respective identifiers of the users.

In Step S805, the memory 120 sends the generated information of preparation status to the input/output unit 110.

In Step S806, the input/output unit 110 displays the received information of preparation status, so as to prompt the user of the distribution server 100 to determine whether to start distribution of the content.

The sequence from Steps S801 through S806 is repeatedly performed at a predetermined interval, so that the users of the distribution server 100 and the distribution controlling device 200 are regularly informed of preparation status for distribution.

The operational sequence illustrated in FIG. 8 may be performed between the memory 120 provided on the distribution server 100 and the input/output unit 210 provided on the distribution controlling device 200. In such a case, the input/output unit 210 provided on the distribution controlling device 200 displays the information of preparation status, so as to prompt the user to determine whether to start distribution of the content.

(4) Distribution of Contents

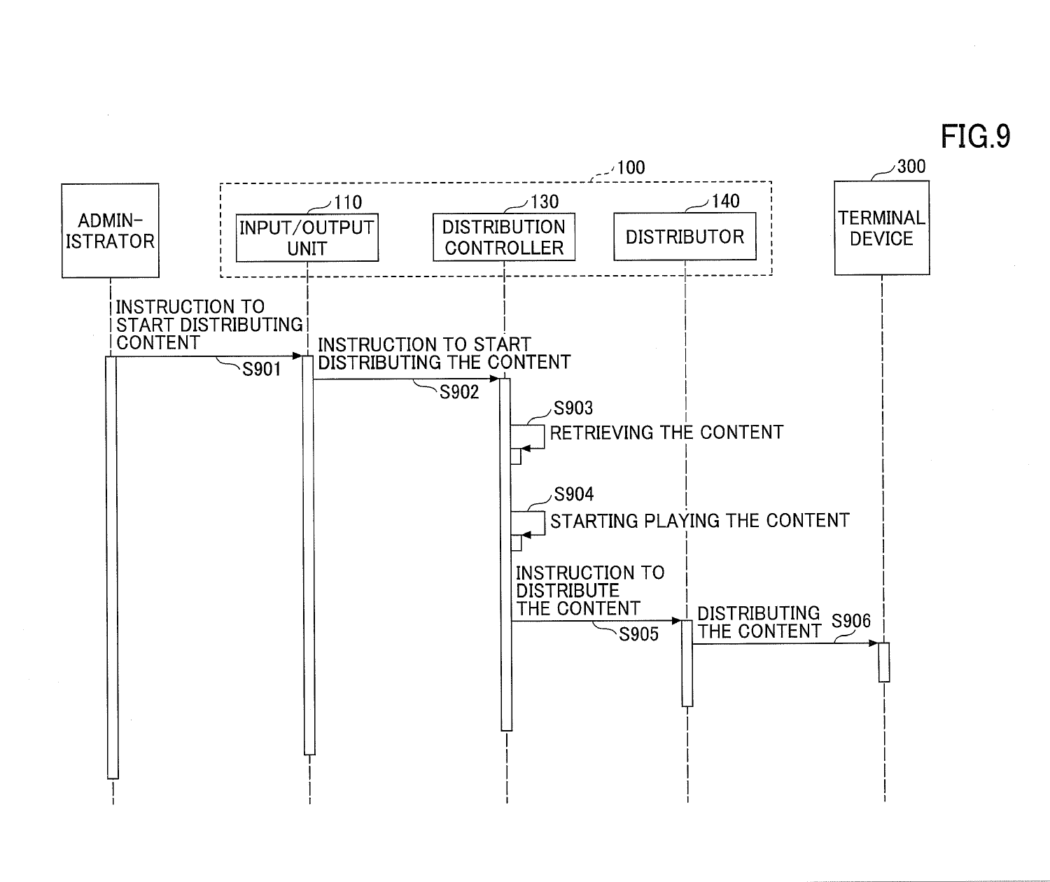

FIG. 9 is a drawing illustrating an example of an operational sequence of distribution of content, according to the first embodiment. The sequence of FIG. 9 follows Step S806 of FIG. 8.

In Step S901, the input/output unit 110 provided on the distribution server 100 receives an instruction to start distribution of the content from the user of the distribution server 100.

In Step S902, the input/output unit 110 instructs the distribution controller 130 to start distribution of the content.

In Step S903, distribution controller 130 retrieves the content to be distributed from the memory 120.

In Step S904, the distribution controller 130 starts playing the retrieved content.

In Step S905, the distribution controller 130 instructs the distributor 140 to distribute the content being played.

In Step S906, the distributor 140 acquires the content being played from the distribution controller 130, and then starts distribution of the content to the destination terminal devices 300 at the same timing. Each of the terminal devices 300 receives and plays the content. The input/output unit 110 may display the content while the distributor 140 distributes the content.

Here, the input/output unit 210 provided on the distribution controlling device 200 may receive the instruction to start distribution of the content from the user of the distribution controlling device 200 and send the instruction to start distribution of the content to the distribution controller 130 provided on the distribution server 100 through the communicator 230.

(5) Determination to Start Distribution

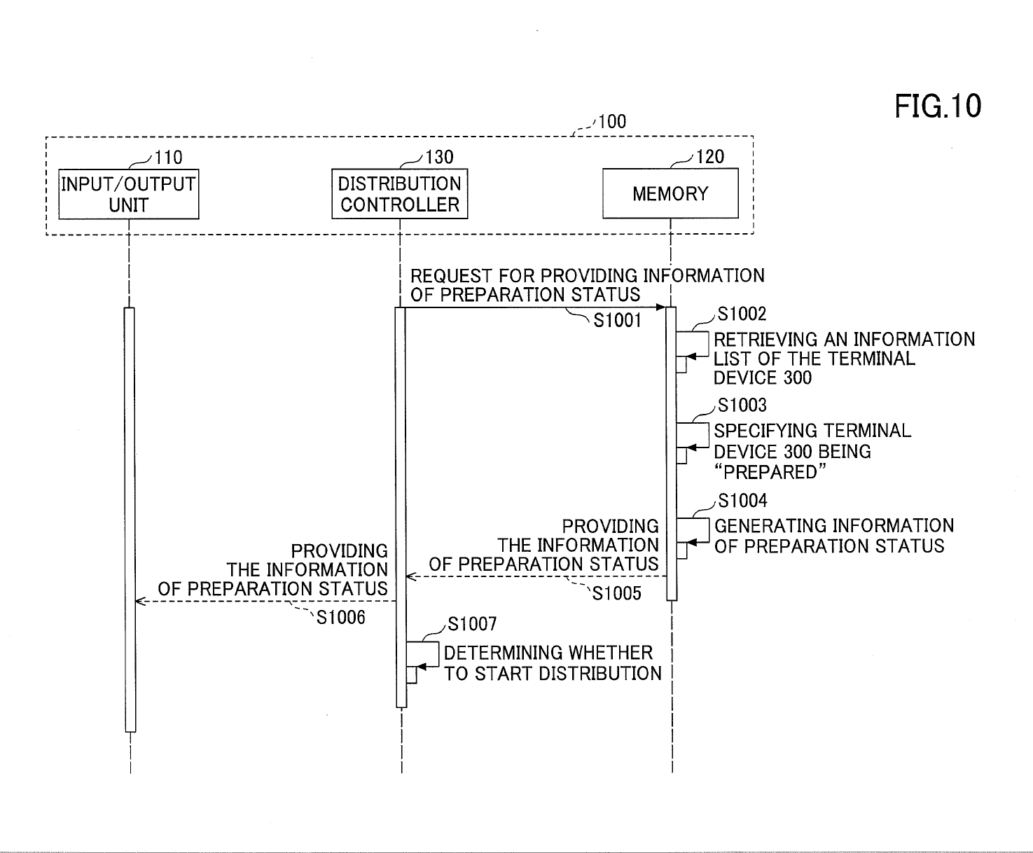

FIG. 10 is a drawing illustrating an example of an operational sequence of determination to start distribution, according to the first embodiment.

In the operational sequence as described above, information of preparation status is displayed on the input/output unit 110 provided on the distribution server 100 or the input/output unit 210 provided on the distribution controlling device 200, so as to receive an instruction to start distribution of content.

Under a predetermined condition, the distribution controller 130 provided on the distribution server 100 may determine to start distribution of content. The operation sequence for such a case is illustrated in FIG. 10.

In Step S1001, the distribution controller 130 provided on the distribution server 100 sends a request for providing information of preparation status to the memory 120.

Steps S1002 through S1004 are the same as Steps S802 through S804, and therefore explanations are omitted.

In Step S1005, the memory 120 provides generated information of preparation status to the distribution controller 130.

In Step S1006, the distribution controller 130 provides the information of preparation status to the input/output unit 110. The input/output unit 110 displays the received information of preparation status.

Here, the distribution controller 130 may send the information of preparation status to the distribution controlling device 200 through the communicator 150. In such a case, the input/output unit 210 provided on the distribution controlling device 200 displays the received information of preparation status.

In such a way, the user of the distribution server 100 or the distribution controlling device 200 may check preparation status of the terminal devices 300 and instruct users of the terminal devices 300 not yet prepared to be prepared.

In Step S1007, the distribution controller 130 determines whether to meet a predetermined condition, based on the generated information of preparation status.

The distribution controller 130 may determine to start distribution of the content in a case of detecting, based on the information of preparation status, that the difference between the number of the terminal devices 300 included in the information list of the terminal devices 300 and the number of the terminal devices 300 whose preparation status is “PREPARED” is in a predetermined range. For example, the range may be predetermined to be approximately 10 percent of the terminal devices 300 included in the list.

The distribution controller 130 may determine to start distribution of the content in a case of detecting, based on the information of preparation status, that the number of the terminal devices 300 included in the information list of the terminal devices 300 and the number of the terminal devices 300 whose preparation status is “PREPARED” match.

Alternatively, the distribution controller 130 may determine to start distribution of the content in a case of detecting, based on the information of preparation status, that the preparation status are “PREPARED” on all of the terminal devices 300 included in the information list of the terminal devices 300.

Upon a determination to start distribution of the content, the sequence described in Steps S903 through S906 is performed.

<Others>

The distribution controlling device 200 and the distribution server 100 may be provided on a single physical device. Further, the memory 120 may be provided on a device disposed on the network 400. In such a case the distribution server 100 acquires various information items from the memory 120.

The distribution server 100 is an example of a distribution apparatus. The communicator 150 is an example of a receiver. The distribution controller 130 is an example of a determiner. The input/output unit 110 and the input/output unit 210 are examples of a display unit.

The distribution server 100 and the distribution controlling device 200 may be provided with a recording medium storing a program code of software for implementing such functions as described in the above embodiment. Needless to say, the above embodiment may be accomplished when the distribution server 100 and distribution controlling device 200 retrieve and execute the program code stored in the recording medium. In such a case, the functions of the embodiment described above are implemented by the program code retrieved from the recording medium, and the recording medium storing the program code is considered to be a constituent part of the embodiment. Here, the recording medium is a recording medium or a non-volatile memory.

Furthermore, implementation of functions as described in the above embodiment may not be performed just by a computer device which retrieves and executes the program code. Needless to say, an OS which operates on the computer device may perform a part or all of the actual processing in accordance with instructions provided by the program code, so as to implement the functions described in the above embodiment.

Further, the present invention is not limited to these embodiments, but various variations and modifications may be made without departing from the scope of the present invention.

According to an aspect of the present invention, distribution of content may be started in accordance with status of destination terminal devices.

What is claimed is:

1. A distribution apparatus comprising:
a receiver configured to receive from one or more terminal devices one or more requests for distributing content, respectively;
a memory;
a determiner configured to acquire, from the memory, information as to the one or more terminal devices for which the content is destined and configured to determine whether to start distributing the content based on a number of the one or more requests for distributing the content received by the receiver and a number of the one or more terminal devices for which the content is destined, the number of the one or more terminal devices being obtained from the information as to the one or more terminal devices for which the content is destined; and
a distributor configured to start distributing the content to the one or more terminal devices for which the content is destined, based on a result of the determination.

2. The distribution apparatus according to claim 1, wherein the determiner determines to start distributing the content, in an event that a difference between the number of the received one or more requests for distributing the content and the number of the one or more terminal devices for which the content is destined is in a predetermined range.

3. The distribution apparatus according to claim 2, wherein the determiner determines to start distributing the content, in an event that the number of the received one or more requests for distributing the content and the number of the one or more terminal devices for which the content is destined match.

4. The distribution apparatus according to claim 2, further comprising:
a display unit configured to display the number of the received one or more requests for distributing the content and the number of the one or more terminal devices for which the content is destined.

5. The distribution apparatus according to claim 1,
wherein the receiver receives one or more identifiers of the respective one or more terminal devices from which the one or more requests for distributing the content are received,
wherein one or more identifiers of the respective one or more terminal devices for which the content is destined are obtained from the information as to the one or more terminal devices for which the content is destined, and
wherein the determiner determines whether to start distributing the content based on a number, out of the number of the received one or more requests for distributing the content, of the one or more requests for distributing the content received from one or more terminal devices having the respective one or more identifiers obtained from the information as to the one or more terminal devices for which the content is destined and the number of the one or more terminal devices for which the content is destined, the number of the one or more terminal devices being obtained from the information as to the one or more terminal devices for which the content is destined.

6. The distribution apparatus according to claim 5, wherein the determiner determines to start distributing the content, in an event that the one or more requests for distributing the content are received from all of the one or more terminal devices having the respective one or more identifiers obtained from the information as to the one or more terminal devices for which the content is destined.

7. The distribution apparatus according to claim 5, wherein the one or more identifiers of the respective one or more terminal devices are one or more MAC (Media Access Control) addresses.

8. The distribution apparatus according to claim 5,
wherein the display unit displays information as to the number of the received one or more requests for distributing the content, and
wherein the one or more identifiers of the respective one or more terminal devices from which the one or more requests for distributing the content are received by the receiver are further obtained from the information as to the number of the received one or more requests for distributing the content.

9. The distribution apparatus according to claim 5,
wherein the display unit displays the information as to the number of the received one or more requests for distributing the content, and
wherein the one or more identifiers of the respective one or more terminal devices from which the one or more requests for distributing the content are not yet received by the receiver are further obtained from the information as to the number of the received one or more requests for distributing the content.

10. A method for distribution of content to one or more terminal devices at once, the method comprising:
receiving from one or more terminal devices one or more requests for distributing content, respectively;
acquiring, from a memory, information as to one or more terminal devices for which the content is destined and determining whether to start distributing the content based on a number of received one or more requests for distributing the content and a number of the one or more terminal devices for which the content is destined, the number of the one or more terminal devices being obtained from the information as to the one or more terminal devices for which the content is destined; and
starting distributing the content to the one or more terminal devices for which the content is destined, based on a result of the determination.
